(19) United States
(12) Patent Application Publication
(10) Pub. No.: US 2005/0217756 A1
(43) Pub. Date: Oct. 6, 2005

(54) Disposable tree stump cutting tip and assembly

(76) Inventor: Guofang Cao, Diamond Bar, CA (US)

Correspondence Address: LAW OFFICES OF J.F. LEE, 17800 CASTLETON STREET, SUITE 383, CITY OF INDUSTRY, CA, 91748, US

(21) Appl. No.: 10/819,534

(22) Filed: Apr. 6, 2004

(51) Int. Cl. B23G 1/00; B23B 39/06; B27M 3/00; A01G 23/06; B27C 1/00; B27C 5/00; B27G 13/00

(52) U.S. Cl. 144/241; 144/218; 144/24.12

(57) ABSTRACT

A disposable tree stump cutting tip and its assembly is disclosed and claimed. Present invention allows the replacement of damaged carbide tip in a most economical fashion so that the shank portion of a cutting tooth can be used repeatedly. The simple construction of present design, using a screw or bolt, with or without a lock nut, reduces the complexity and cost of carbide tip replacement.

### RELATED APPLICATIONS

The present application is related to the following three applications:

| | |
|---|---|
| 1. Application Number: 10/767049 | Filing Date: Jan. 29, 2004 |
| 2. Application Number: 10/777868 | Filing Date: Feb. 11, 2004 |
| 3. Application Number: 10/781216 | Filing Date: Feb. 17, 2004 |

### FIELD AND BACKGROUND OF THE INVENTION

The present invention relates generally to design and construction of carbide tip used on machines for tree stump cutting and grinding.

Modern tree stump cutting and grinding machines in general have a rotary disc driven by motor; the disc has multiple teeth attached at the outer edge of the disc so that when the disc is spinning/rotating, the teeth on the edge repeatedly cuts towards the tree stump, or any work piece.

In the prior art teeth structures, and in use today, the cutting tooth is formed by a steel shank, upon which a carbide tip is welded, to serve as the cutting blade. In most cases, the carbide tip is made of tungsten and cobalt alloy. Repeated use of the carbide tip will invariably result in damage to said carbide tip due to the unavoidable hard impact on the carbide tip.

Some prior art patents teach the construction of removable cutting teeth, such as U.S. Pat. Nos. 5,743,314 and 6,601,620. However, these prior art patents teach the removal of the cutting tip along with the shank portion upon which the tip sits.

The complexity and replacement costs of these prior arts are thus a undesirable feature.

### OBJECTS AND SUMMARY OF THE INVENTION

Present invention provides an improved and simplified design and assembly of the carbide tip, so that the complexity and the cost of replacing new carbide tips are greatly reduced. By using a screw (or bolt) to secure the carbide tip in place, the cost for replacing new carbide tip is greatly reduced.

### DESCRIPTION OF THE DRAWINGS

The accompanying drawings, which are incorporated in and constitute a part of this specification, illustrate the preferred embodiment of the invention and together with the description, serve to explain the principles of the invention.

A brief description of the drawings is as follows:

FIG. 1 shows the exploded view of the carbide tip design and assembly in present invention.

FIGS. 2a and 2b show the perspective view and side view of present invention.

FIG. 3 shows the exploded view of present invention, with a lock nut added. Note that present implementation allows the inside of the seat (upon which the carbide tip is secured) to be smooth, without the machined thread lines.

FIGS. 4a and 4b show the perspective view and side view of present invention with a lock nut added.

FIGS. 5a and 5b show the perspective view and top view of carbide tip in oval shape.

FIGS. 5c and 5d show the perspective view and top view of carbide tip in round shape.

FIG. 5e shows the two angles (a and b) formed on the carbide tip, so that the screw is situated in a recessed position (angle b) in the center of the carbide tip, and that the carbide tip has a sharp cutting angle (a) less than 90 degrees.

FIG. 6 shows the perspective view of present invention as the carbide tip is assembled to the teeth on the rotary disc.

### DETAILED DESCRIPTION OF THE PREFERRED EMBODIMENT

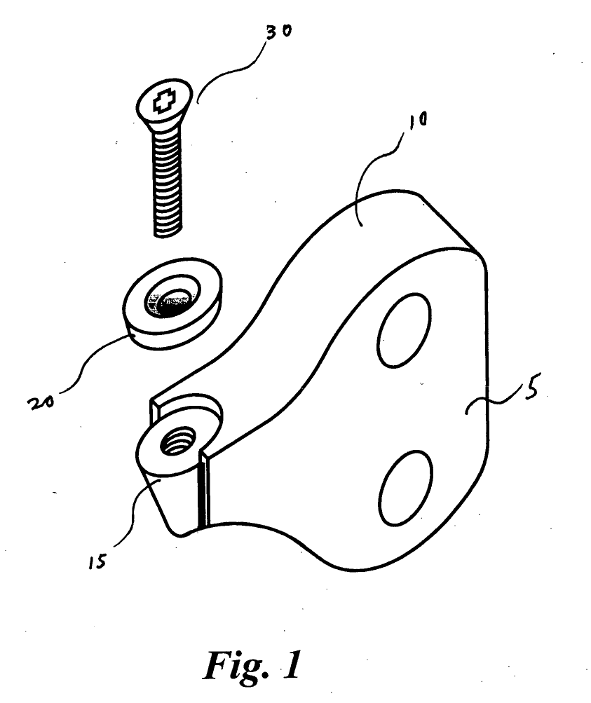

In FIG. 1, a seat 15 is formed at the cutting end of the shank 10 on a cutting tooth 5. Relative to the surface of shank 10, surface of seat 15 is in a recessed position to allow a carbide tip 20 to be fitted on.

A screw 30, or a bolt, will be used to secure said carbide tip 20 to the seat 15. Note that the inside tube-like space of the seat 15 contains machined thread lines to receive the screw 30.

Although the top of screw 30 shows a cross imprint (for Philips screwdriver), it can also be a flat-head type or an internal hexagonal type.

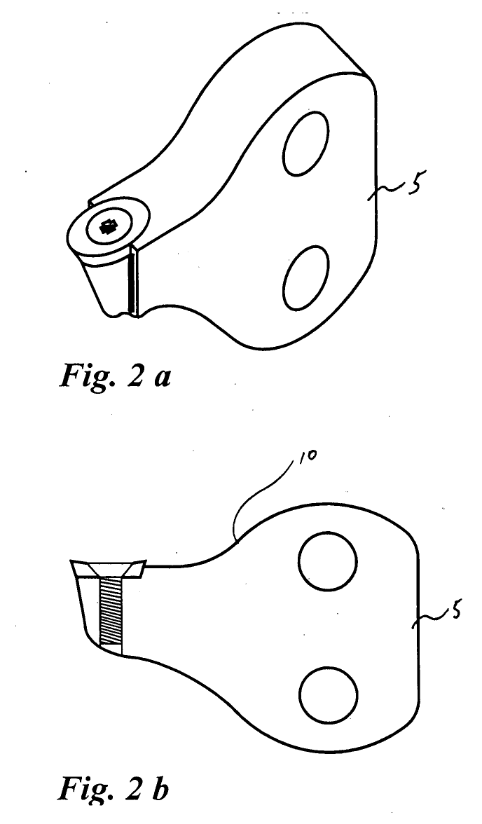

FIG. 2a shows the perspective view of the carbide tip 20 described above, in assembled fashion.

FIG. 2b shows the side view of the carbide tip 20 described above, in assembled fashion.

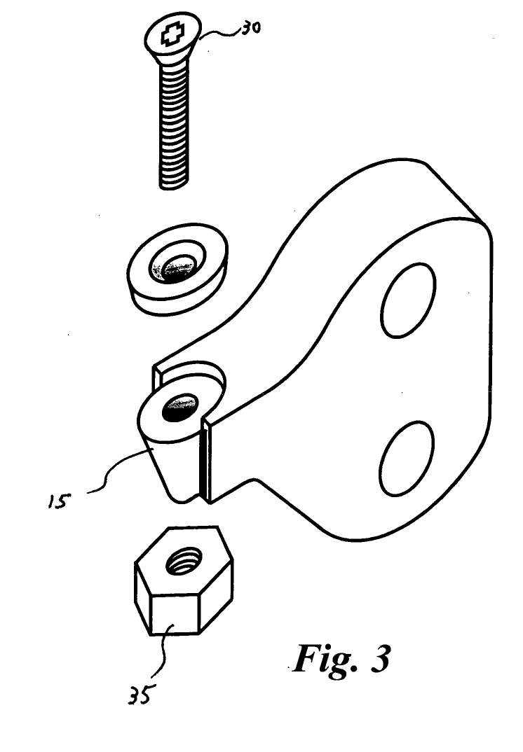

FIG. 3 shows the use of a lock nut 35 to secure the screw 30 and carbide tip 20 to the seat 15. With lock nut 35, the inside tube-like space of seat 15 need no machined thread lines.

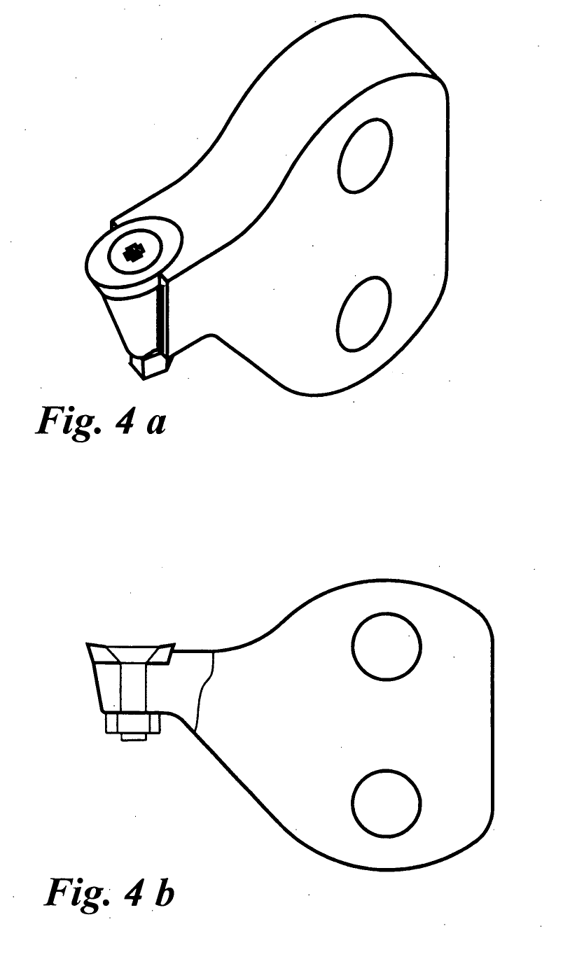

FIG. 4a shows the perspective view of the carbide tip 20 described above, in assembled view.

FIG. 4b shows the side view of the carbide tip 20 described above, in assembled fashion.

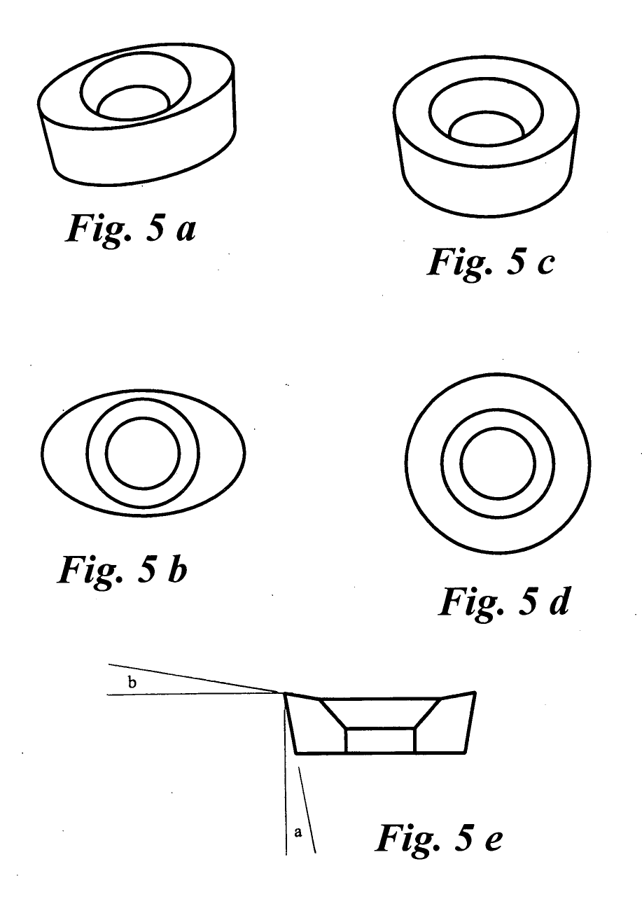

FIGS. 5a and 5b show the carbide tip 20 can be made into an oval shape. FIGS. 5c and 5d show the carbide tip can be made into a round shape.

FIGS. 5a through 5e show that there is a bevel-angled opening in the center of the carbide tip for receiving the top of said screw 30, so that the top of said screw will not protrude out relative to the surface of the carbide tip 20. And further that the angles of the carbide tip 20 are formed to allow the top of said screw 30 to be in a recessed position relative to the surface of said carbide tip 20 (angle b) and that the cutting angle (a) is less than 90 degrees for more effective cutting.

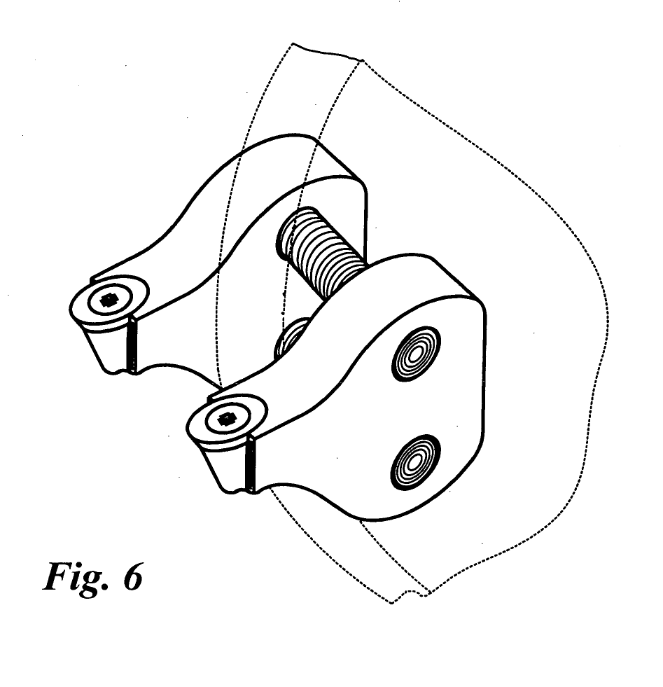

FIG. 6 shows the embodiment of present invention as affixed to two teeth on a rotary disc.

1. Disposable tree stump cutting tip and assembly, comprising:
a. A cutting tooth having a recessed seat at end of its shank portion, the inside tube-like space of said seat having machined thread lines;
b. A carbide tip with bevel-angled opening; and,
c. A screw for securing said carbide tip to said seat on the cutting tooth.

2. The carbide tip and its assembly of claim 1, wherein the angles of said carbide tip are so made as to allow the top of said screw to sit below the surface of said seat, and the cutting angle is less than 90 degrees.

3. The carbide tip and its assembly of claim 2, wherein a lock nut is used at end of said screw to secure said carbide tip and said seat together.

4. The carbide tip and its assembly of claim 3, wherein the inside tube-like space of said seat has no machined threaded lines.
